(19) United States
(12) Patent Application Publication
(10) Pub. No.: US 2004/0078385 A1
(43) Pub. Date: Apr. 22, 2004

(54) Content reception program content receiving method

(76) Inventor: Tomohiro Yamada, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/468,009

(22) PCT Filed: Feb. 18, 2002
(86) PCT No.: PCT/JP02/01385

(30) Foreign Application Priority Data
Feb. 23, 2001 (JP) 2001-048022

(51) Int. Cl. G06F 17/00

(52) U.S. Cl. 707/102

(57) ABSTRACT

A content delivery system includes a server (300), and each server (300) has advertisement information advertising itself as to what kind of services are offered. The advertisement information is arbitrarily downloadable by a client (100). Furthermore, the downloaded advertisement information is stored in a memory within a content reproducing apparatus (400). When the content reproducing apparatus (400) is connected, the client (100) reads out the advertisement information stored in the memory within the content reproducing apparatus (400). Therefore, this eliminates a need to access each server so as to browse a homepage, and enables to easily know what kind of services each server offers.

### TECHNICAL FIELD

The present invention relates to a content receiving program and a content receiving method both executed by a client computer (hereinafter briefly referred to as a client) to which a server computer (hereinafter briefly referred to as a server) system that delivers a content such as a music, an image, and etc., and a content reproducing apparatus that reproduces the delivered content are connected as required.

### PRIOR ART

Recently, there are an increasing number of services delivering various contents using an Internet. In the past, in order to download the content using such the delivery service, an Internet browser is used to assess a server of a delivery source, and then, a desired content is selected on its homepage, and downloaded.

However, in the prior art, in order to know which server offers what kind of services, it needs to access each server and ascertain the content of services on the respective homepages one by one, and hence troublesome.

### SUMMARY OF THE INVENTION

Therefore, it is a primary object of the present invention to provide a content receiving program and a content receiving method capable of eliminating a need to do a troublesome task such as browsing a homepage, and knowing what kind of services a server offers.

Furthermore, it is also another object of the present invention to provide a client and a content receiving system capable of obtaining the same effect as such the content receiving program and the content receiving method.

The present invention is a content receiving program executed by a client computer to which a server system that delivers a content and a content reproducing apparatus that reproduces the delivered content are connected as required, and comprises following: (a) a reading-out step for reading out advertisement information from a memory of the content reproducing apparatus when the content reproducing apparatus is connected to the client computer; (b) a connecting step for connecting the client to the server system based on the advertisement information; and (c) an updating step for updating the advertisement information of the memory by the new advertisement information transmitted from the server system.

In the present invention, the client reads out the advertisement information from the memory of the content reproducing apparatus according to the reading-out step when the content reproducing apparatus is connected to the client. This allows the client to know what kind of services the server system offers. Furthermore, the client executes the connecting step for connecting to the server system based on the advertisement information. Herein, when the new advertisement information is transmitted from the server system, the client updates the advertisement information within the memory by the new advertisement information according to the updating step.

In a certain embodiment of the present invention, the server system includes a plurality of servers that hold the content and the advertisement information, and the advertisement information includes address information of the server of an advertisement transmitting source. Furthermore, in the connecting step, a connection is made to each of the server computers according to the address information.

It is noted that the memory stores the advertisement information for each of the servers. Furthermore, the updating step includes a detecting step for detecting from the memory the advertisement information corresponding to the connecting server, and an advertisement information updating step for updating the advertisement information detected in the detecting step by the new advertisement information transmitted from the connecting server.

In addition, the advertisement information stored in the memory includes timing information showing a timing of creating the advertisement, and the updating step further includes a transmitting step for transmitting to the connecting server the timing information included in the advertisement information detected in the detecting step. Then, in the advertisement information updating step, an updating is carried out when the new advertisement information is transmitted toward the timing information.

In another embodiment of the present invention, the server system includes a plurality of first servers that hold the content, and a second server that holds the advertisement information, and in the connecting step, a connection is made to the second server.

It is noted that the advertisement information includes address information of the second server, and in the connecting step, a connection is made to the second server according to the address information.

In a certain aspect, the present invention is a content receiving method wherein a client receives a content delivered from the server system and transfers the same to the content reproducing apparatus to which a server system that delivers a content and a content reproducing apparatus that reproduces a delivered content are connected as required, and comprises following steps: (a) a step for reading out advertisement information from a memory of the content reproducing apparatus when the content reproducing apparatus is connected to the client; (b) a step for connecting the client to the server system based on the advertisement information; and (c) a step for updating the advertisement information of the memory by the new advertisement information transmitted from the server system.

In this aspect, when the content reproducing apparatus is connected to the client, the client reads out the advertisement information from the memory of the content reproducing apparatus. This allows the client to know what kind of services the server offers. Furthermore, the client connects it to the server system based on the advertisement information. Herein, when the new advertisement information is transmitted from the connecting server system, the client updates the advertisement information within the memory by the new advertisement information.

The present invention is a client computer to which a server system that delivers a content and a content reproducing apparatus that reproduces a delivered content are connected as required, and comprises: a reading-out means for reading out advertisement information from a memory of the content reproducing apparatus when the content reproducing apparatus is connected to the client; a connection means for connecting the client to the server system based on the advertisement information; and an updating means for updating the advertisement information of the memory by the new advertisement information transmitted from the server system.

In the present invention, when the content reproducing apparatus is connected to the client, the reading-out means reads out advertisement information from the memory of the content reproducing apparatus. This allows the client to know what kind of services the server system offers. Furthermore, the connection means connects the client to the server system based on the advertisement information. Herein, when the new advertisement information is transmitted from the server system, the updating means updates the advertisement information within the memory by the new advertisement information.

In another aspect, the present invention is a content receiving system, and comprises: a server system that delivers a content; a content reproducing apparatus that reproduces a delivered content; and a client that reads out advertisement information from a memory of the content reproducing apparatus, connects the client to the server system based on the advertisement information, and updates the advertisement information of the memory by the new advertisement information transmitted from the server system.

In this aspect, the client reads out the advertisement information from the memory of the content reproducing apparatus when the content reproducing apparatus is connected thereto. This allows the client to know what kind of services the server system offers. Furthermore, the client connects itself to the server system based on the advertisement information. Herein, when the new advertisement information is transmitted from the server system, the client updates the advertisement information of the memory by the new advertisement information.

The present invention is a client to which a server system that delivers a content and a content reproducing apparatus that reproduces a delivered content are connected as required, and comprises following programs: a reading-out program for reading out advertisement information from a memory of the content reproducing apparatus when the content reproducing apparatus is connected to the client computer; a connecting program for connecting to the server system based on the advertisement information; and an updating program for updating the advertisement information of the memory by the new advertisement information transmitted from the server system.

According to the present invention, the client reads out advertisement information from a memory of the content reproducing apparatus when the content reproducing apparatus is connected to the client. Therefore, this eliminates a troublesome task for an operator operating the client to browse a homepage, and enables to know what kind of services the server offers.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing whole structure of one embodiment of the present invention;

FIG. 2 is a block diagram showing schematic structure of a server in FIG. 1;

FIG. 3 is a block diagram showing schematic structure of a client in FIG. 1;

FIG. 4 is a block diagram showing schematic structure of a music reproducing apparatus in FIG. 1;

FIG. 5 is an illustrative view showing data structure within a memory of the music reproducing apparatus in FIG. 4;

FIG. 6 is an illustrative view showing all entire flow when advertisement information is transmitted and received in the structure shown in FIG. 1;

FIG. 7 is an illustrative view showing one displaying example of a display of the client in FIG. 3;

FIG. 8 is an illustrative view showing of one displaying example of a display of the client under a different situation from that of FIG. 7;

FIG. 9 is an illustrative view showing data structure within the memory of the music reproducing apparatus under a different situation from that of FIG. 5;

FIG. 10 is a flowchart showing a processing procedure of a CPU of the client when the advertisement information is transmitted and received according to the flow in FIG. 6;

FIG. 11 is a flowchart showing details of an advertisement information downloading process in FIG. 10;

FIG. 12 is a flowchart showing a processing procedure of a CPU of the music reproducing apparatus when connected to the client in the flow in FIG. 6;

FIG. 13 is a flowchart showing a processing procedure of the CPU of the music reproducing apparatus when the advertisement information is transmitted from the client in the flow in FIG. 6;

FIG. 14 is a flowchart showing a processing procedure of CPUs of each server when the advertisement information is transmitted and received between the client according to the flow in FIG. 6;

FIG. 15 is an illustrative view describing another embodiment of the present invention, and showing an entire flow when the advertisement information is transmitted according to a procedure different from that in FIG. 6;

FIG. 16 is a flowchart showing details of the advertisement information downloading process when the client downloads the advertisement information from each server according to the flow shown in FIG. 15;

FIG. 17 is a flowchart showing a processing procedure of the CPU of each server when the advertisement information is transmitted and received between the client according to the flow shown in FIG. 15;

FIG. 18 is an illustrative view showing whole structure of still another embodiment of the present invention;

FIG. 19 is an illustrative view showing an entire flow when the advertisement information is transmitted in the structure shown in FIG. 18;

FIG. 20 is a flowchart showing details of the advertisement information downloading process when the client downloads the advertisement information from each server according to the flow shown in FIG. 19;

FIG. 21 is an illustrative view describing a certain embodiment of the present invention, and showing an entire flow when a data file is downloaded from an arbitrary server;

FIG. 22 is an illustrative view showing one displaying example of a display of the client in the flow shown in FIG. 21;

FIG. 23 is an illustrative view showing data structure of a data file downloaded in the flow in FIG. 21;

FIG. 24 is a flowchart showing a processing procedure of a CPU of the client when the data file is downloaded from the arbitrary server according to the flow shown in FIG. 23;

FIG. 25 is a flowchart showing a processing procedure of a CPU of the server when accessed from the client in the flow shown in FIG. 23;

FIG. 26 is a flowchart showing a processing procedure of a CPU of the music reproducing apparatus when the data file is forwarded from the client in the flow shown in FIG. 23; and

FIG. 27 is a flowchart describing still another embodiment of the present invention, and showing a processing procedure of the CPU when the music is reproduced by the music reproducing apparatus.

### BEST MODE FOR PRACTICING THE INVENTION

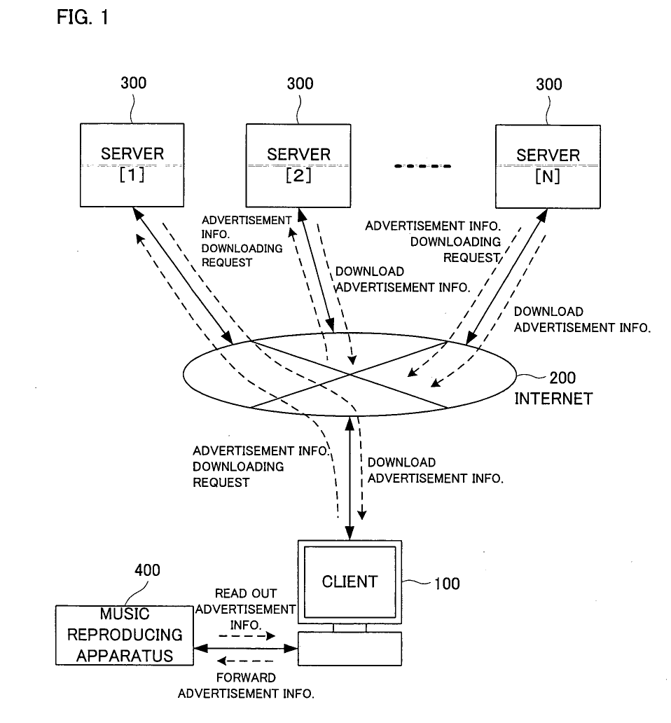

Referring to FIG. 1, a client 100 of this embodiment is a personal computer having a communication function, and capable of arbitrarily accessing a plurality of servers (WEB servers) 300, 300, . . . , through an Internet 200. In addition, a handheld music reproducing apparatus 400 is also connected to the client 100 as a content reproducing apparatus, as required.

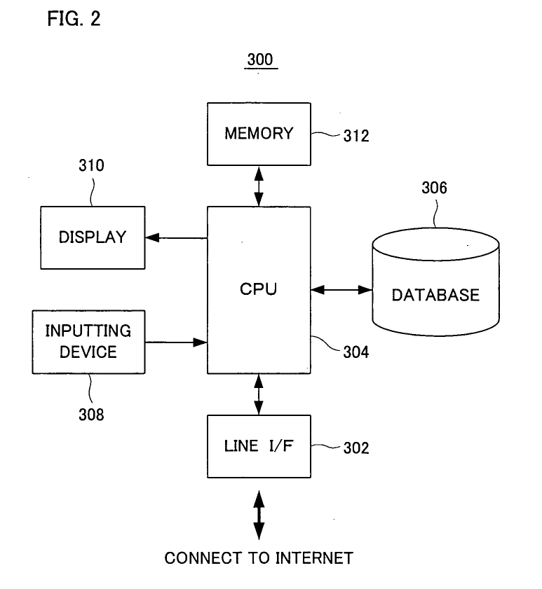

Each server 300, 300, . . . , is for delivering a music content, and has a CPU (Central Processing Unit) 304 connected to the Internet 200 via an external interface as shown in FIG. 2, and a database 306 connected to this CPU 304. It is noted that a plurality of data files each corresponding to each of a plurality of music contents, and advertisement information (described later) are held in the database 306. Furthermore, an imputting device 308 to which various instructions are input from an operator operating the server 300, a display 310 displaying various kinds of information according to operations of the CPU 304, and a memory 312 in which a control program for controlling an operation of the CPU 304 is stored are also connected to the CPU 304, respectively.

Herein, when the client 100 accesses one of the servers 300, and orders a desired music content, the order-destination server 300 extracts from the database 306 the data file corresponding to the music content ordered from the CPU 304. Then, the CPU 304 transmits the extracted data file to the order-source client 100 through the Internet 200.

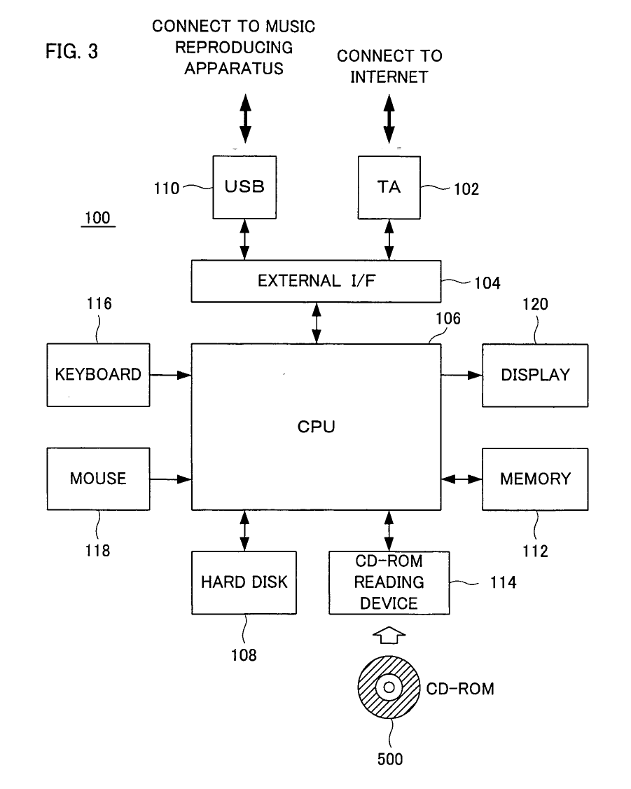

Referring to FIG. 3, the data file transmitted through the Internet 200 is fetched inside the client 100 via a terminal adaptor 102. This data file is input into a CPU 106 via an external interface 104. The CPU 106 temporarily saves, that is, downloads, the input data file into a hard disk 108. At the same time, the CPU 106 forwards the downloaded data file to the music reproducing apparatus 400 via the external interface 104 and a USB (Universal Serial Bus) terminal 110.

It is noted that the CPU 106 is operated according to a content receiving program stored in a memory 112. This content receiving program is supplied by a CD-ROM 500. More specifically, the client 100 is provided with a CD-ROM reading device 114 for reading out the content receiving program recorded in the CD-ROM 500. The content receiving program read out by this CD-ROM reading device 114 is installed into the hard disk 108 via the CPU 106. The CPU 106 temporarily moves the installed content receiving program from the hard disk 108 to the memory 112, and as a result of accessing the memory 112, the content receiving program is executed. It is noted that a keyboard 116 and a mouse 118 as an inputting device for inputting various instructions, and a display 120 that displays various kinds of information according to operations of the CPU 106 are connected to the CPU 106.

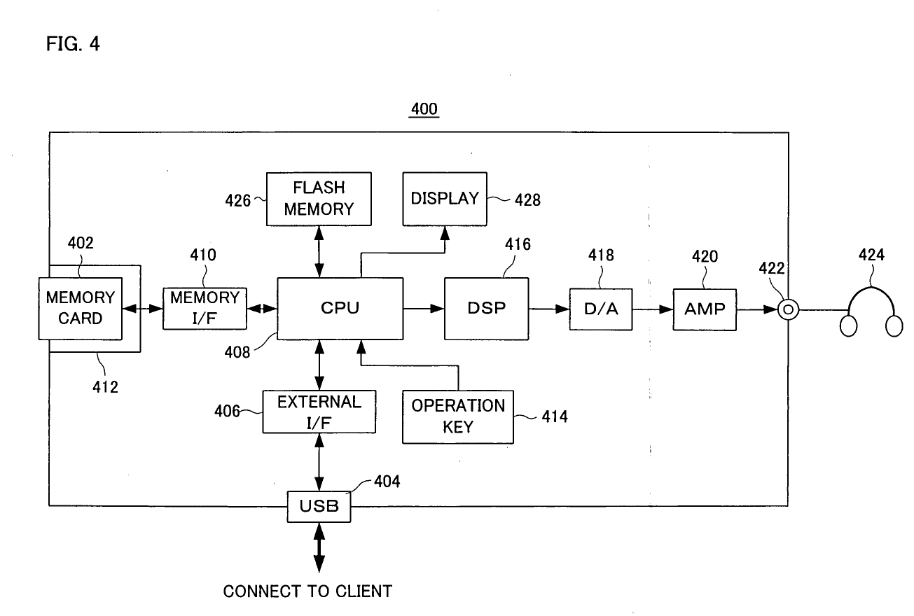

Referring to FIG. 4, the data file forwarded from the client 100 is fetched into the music reproducing apparatus 400 via a USB terminal 404. This data file is input into a CPU 408 via an external interface 406. The CPU 408 records the input data file into a memory card 402 via a memory interface 410. It is noted that the memory card 402 is a detachable recording medium, and electrically connected to the CPU 408 via the memory interface 410 when attached to a slot 412.

When reproducing a music based on the data file recorded in the above-described memory card 402, such the instruction is input from an operation key 414. More specifically, a reproducing key (not shown) forming an operation key 414 is depressed. Then, the CPU 408 fetches the data file from the memory card 402 via the memory interface 410, and supplies this to a DSP (Digital Signal Processor) 416. The DSP 416 decodes encoded music data included in this data file, and inputs the decoded music data into a D/A converter 418. The D/A converter 418 converts the input music data into an analog music signal, and the converted music signal is input into a head phone 424 via an audio amplifier 420 and an output terminal 422. Thereby, the music is reproduced. It is noted that when the music is thus reproduced, the music reproducing apparatus 400 may not be connected to the client 100. In addition, in order to suspend this reproducing operation, a suspension key (not shown) forming the operation key 414 may be depressed.

Incidentally, each server 300, 300, . . . , of this embodiment holds the advertisement information in its own respective databases 306 as described above. The advertisement information is information for each server to advertise itself. Herein, URL (Uniform Resource Locator) information of each server 300, and information describing what kind of services each server offers using a text and an image are held in the respective databases 306 in an HTML (Hyper Text Markup Language) format as the advertisement information. It is noted that a content of the advertisement information can be updated in the respective servers 300 as required.

In correspondence with such the servers 300, 300, . . . , the client 100 has a function of downloading the advertisement information from each server 300, 300, . . . , and forwarding the downloaded advertisement information to the music reproducing apparatus 400. Furthermore, the music reproducing apparatus 400 is provided with a flash memory (hereinafter briefly referred to as a memory) 426 for storing the advertisement information forwarded from the client 100.

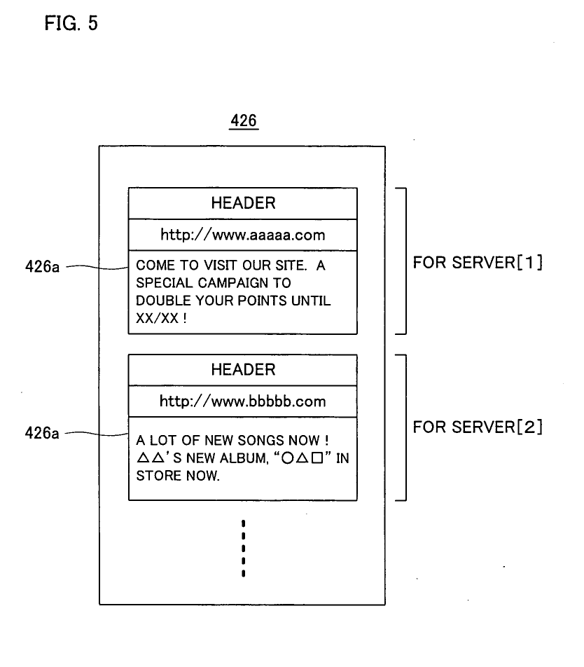

Referring to FIG. 5, the memory 426 has a plurality of storing areas 426a, 426a, 426a, . . . , each of which corresponds to each of the servers 300, 300, . . . ,. It is noted that it is registered in advance for determining to which storing area 426aeach server corresponds. In addition, subsequent to headers of each storing area 426a, the URL information of the server 300 corresponding to each other, and the information showing what kind of services each server offers are stored in this order.

Furthermore, the client 100 has a function of reading out the advertisement information from the memory 426 when the music reproducing apparatus 400 is connected thereto. This eliminates a need for the client 100 to take the trouble to access each server 300, 300, . . . , so as to browse each homepage, and enables to know what kind of services each server 300, 300, . . . , offers from the read advertisement information.

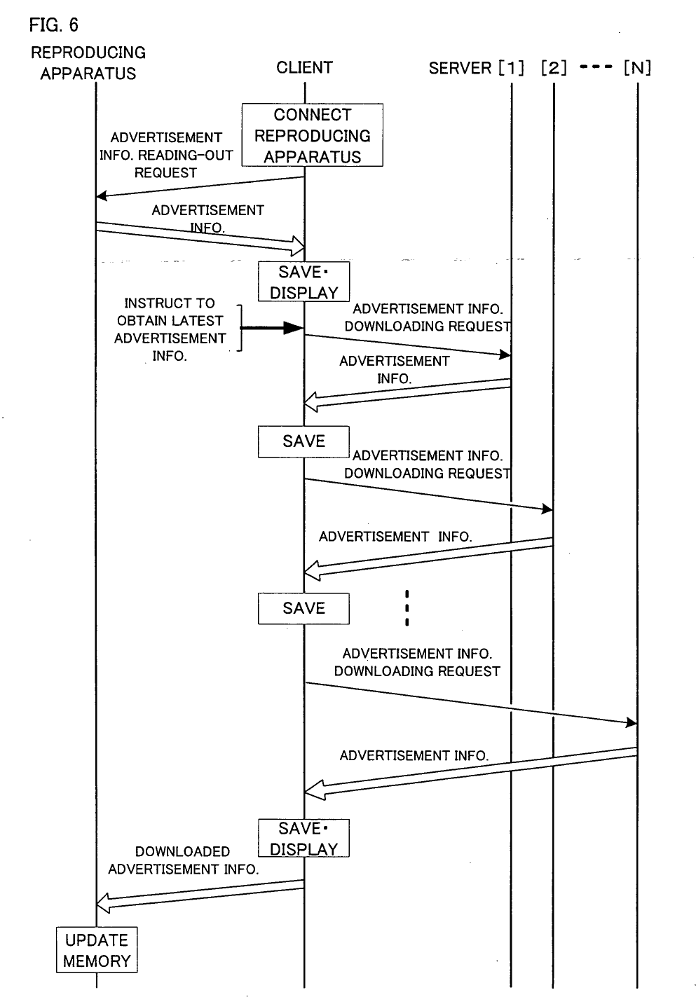

A series of flows When the advertisement information is thus transferred among the client 100, each server 300, 300, . . . , and the music reproducing apparatus 400 will be described in detail referring to FIG. 6.

Provided that the advertisement information as shown in the above-described FIG. 5 is now stored within the music reproducing apparatus 400, and the music reproducing apparatus 400 and the client 100 are not yet connected with each other, for example.

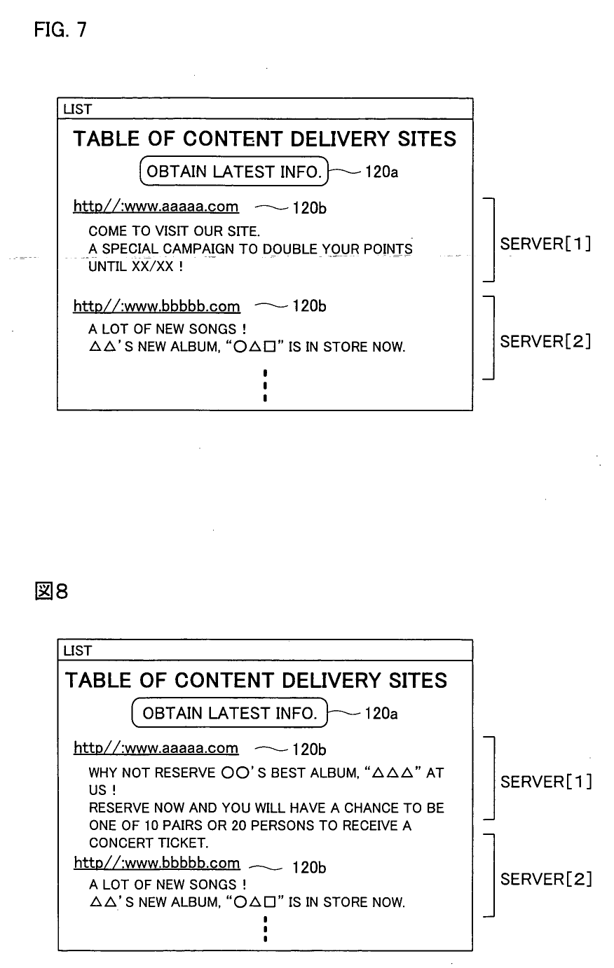

With this state, when the music reproducing apparatus 400 is connected to the client 100, the client 100 issues a reading-out request of the advertisement information to the music reproducing apparatus 400. The music reproducing apparatus 400 reads out all advertisement information from the memory 426 in response to the applied reading-out request, and transmits these information to the client 100. The client 100 temporarily saves the read advertisement information into the hard disk 108, and displays this information on its own display 120 as shown in FIG. 7. This display of the display 120 allows the operator operating the client 100 to know what kind of services each server 300, 300, . . . , offers.

Then, as a result of a button 120a titled “obtain latest information” displayed in an approximately upper position in the center of the screen in FIG. 7 being clicked by the mouse 118 (pointer), the client 100 accesses in order each server 300, 300, . . . , so as to download each advertisement information. More specifically, a [1st] server 300 is accessed out of N of servers 300, 300, . . . , registered in the memory 426. The access to this server 300 is carried out based on the URL information included in the advertisement information. Next, the client 100 issues to the server 300 of an access destination a download request of the advertisement information. Then, the access server 300 transmits the advertisement information owned by itself to the client 100 in response to this download request. The client 100 temporarily downloads the advertisement information to be transmitted into the hard disk. Then, upon completion of this download, next, the client 100 access a [2nd] server 300 so as to download the advertisement information. Subsequently, the access is similarly made in order until a [Nth] server 300 so as to download the advertisement information.

Upon completion of downloading the advertisement information from all servers 300, 300, . . . , the client 100 displays the downloaded latest advertisement information on its own display as shown in FIG. 8. It is noted that this FIG. 8 shows an example that regarding the [1st] server 300, the advertisement information is updated compared to that before being downloaded shown in FIG. 7, and regarding the [2nd] client 300, the advertisement information is not updated compared to that before being downloaded. The client 100 displays on this display and forwards the latest advertisement information to the music reproducing apparatus 400.

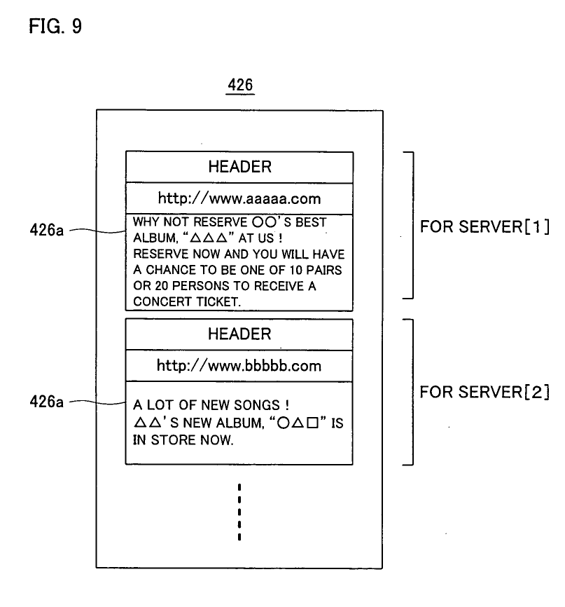

The music reproducing apparatus 400 receives the advertisement information forwarded from the client 100, and updates the advertisement information stored within the memory 426 by the received advertisement information. Thereby, the data within the memory 426 is rewritten as shown in FIG. 9.

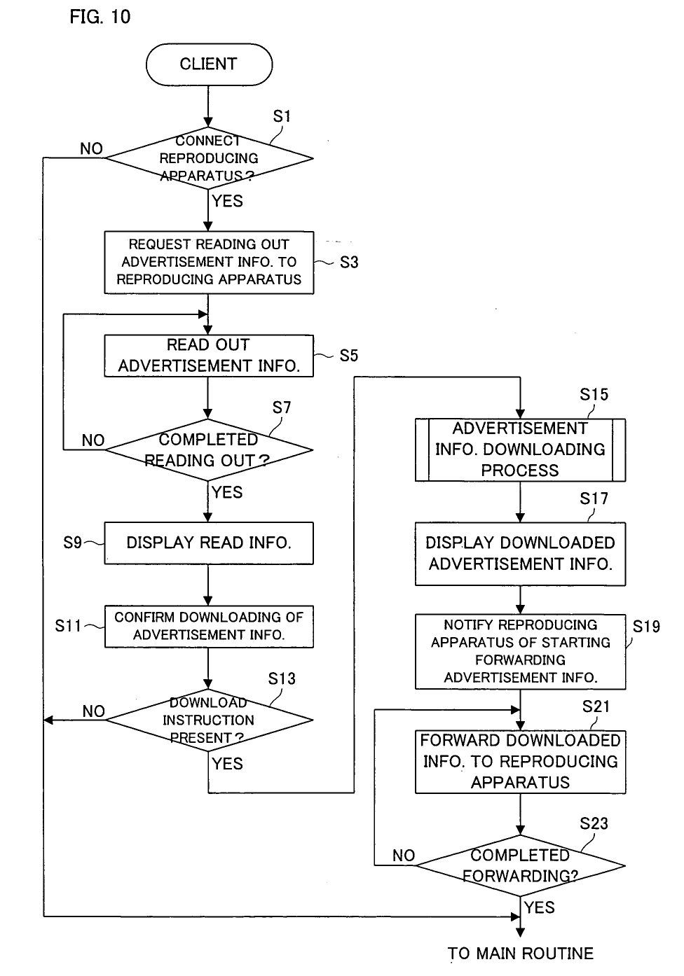

In order to transmit the advertisement information among each server 300, 300, . . . , and the music reproducing apparatus 400 according to the flow thus shown in FIG. 6, the CPU 106 of the client 100 processes a flowchart shown in FIG. 10.

As shown in this FIG. 10, when the CPU 106 recognizes that the music reproducing apparatus 400 is connected in a step S1, the CPU 106 issues to the music reproducing apparatus 400 the reading-out request of the advertisement information stored in the memory 426 in a step S3. Then, the CPU 106 receives (reads out) the advertisement information transmitted from the music reproducing apparatus 400 in response to this reading-out request, and temporarily saves this advertisement information into the hard disk in a step S5. In a step S7, after confirming that it is completed to read out this advertisement information, the CPU 106 advances to a step S9 so as to display the read advertisement information on the display 120. This causes the above-described screen shown in FIG. 7 to be displayed on the display 120.

Then, the CPU 106 confirms whether or not to download the latest advertisement information from each server 300, 300, . . . , in a step S11. This confirmation is performed by displaying the above-described “latest information obtaining” button 120a. If an instruction of downloading the latest advertisement information is made from the operator in a step S13, that is, if it is confirmed that the “latest information obtaining” button 120a is clicked, the CPU 106 executes an advertisement information downloading process in a step S15 for downloading each advertisement information from each server 300, 300, . . . ,. On the other hand, in a case of confirming that the latest advertisement information is not downloaded in the step S13, that is, in a case that the operator has done a process other than clicking the “latest information obtaining” button 120a, the CPU 106 returns to a main routine (not shown).

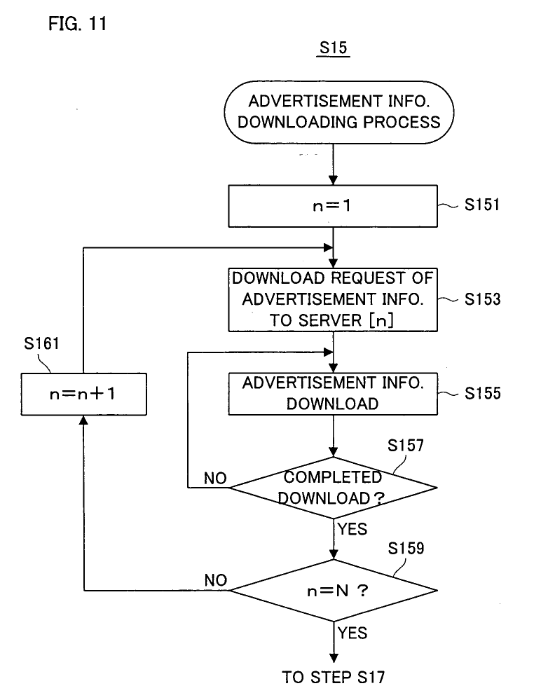

Referring to FIG. 11, in the advertisement information downloading process, firstly, the CPU 106 sets a server index n (n=1, 2, . . . , N) for specifying an arbitrary server 300 to an initial value, that is, n=1, in a step S151. Then, the CPU 106 issues to the [n th] server 300 the download request of the latest advertisement information held in the server 300 in a step S153, and executes downloading in a step S155. Next, after confirming that it is completed to download in a step S157, the CPU 106 advances to a step S159 so as to confirm whether or not it is completed to download the advertisement information from all the servers 300, 300, . . . ,. Herein, if it is determined that it is not yet completed to download the advertisement information from all the servers 300, 300, . . . , the CPU 106 advances to a step S161 so as to download the latest advertisement information from a subsequent server. Then, the CPU 106 returns to the step S153 after updating the server index n in the step S161. On the other hand, if it is determined that it is completed to download the latest advertisement information from all the servers 300, 300, . . . , in the step S159, the CPU 106 terminates this advertisement information downloading process, and advances to a succeeding step S17 in FIG. 10.

In the step S17, the CPU 106 displays on the display 120 the advertisement information downloaded in the advertisement information downloading process. Then, the CPU 106 advances to a step S19 so as to forward the downloaded advertisement information to the music reproducing apparatus 400, and informs the music reproducing apparatus 400 of starting forwarding this advertisement information. After this notification, the CPU 106 advances to a step S21 so as to forward to the music reproducing apparatus 400 the downloaded advertisement information. Next, after confirming that this forwarding is completed in a step S23, the CPU 106 returns to the main routine.

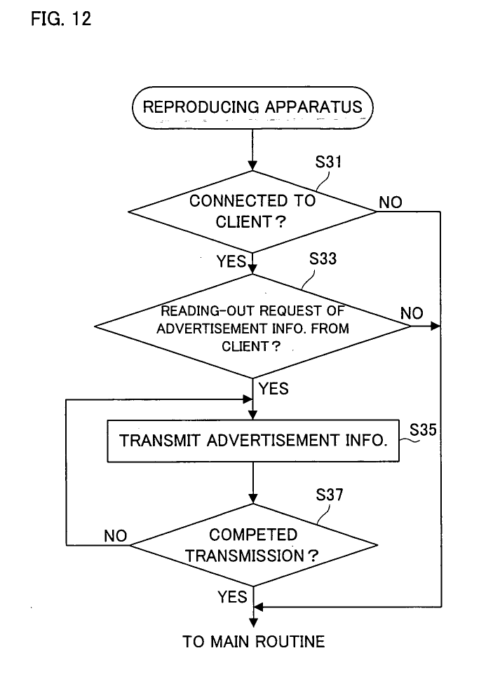

In correspondence with such the process of the CPU 106 at a side of the client 100, the CPU 408 of the music reproducing apparatus 400 processes a flowchart shown in FIG. 12 when the music reproducing apparatus 400 is connected to the client 100.

That is, after confirming that the music reproducing apparatus 400 is connected to the client 100, the CPU 408 confirms whether or not the reading-out request of the advertisement information is issued from the client 100 (CPU 106) in a step S33. Herein, if it is confirmed that the reading-out request of the advertisement information is issued from the client 100, the CPU 408 advances to a step S35 so as to read out the advertisement information stored in the memory 426, and transmits the read advertisement information to the client 100. Next, after confirming that it is completed to transmit the advertisement information in a step S37, the CPU 408 returns to its own main routine (not shown).

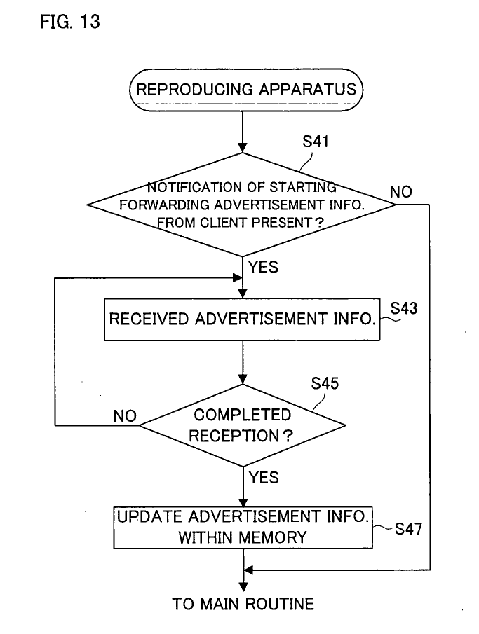

In addition, on receipt of a notification of starting forwarding the latest advertisement information from the client 100, the CPU 408 processes a flowchart shown in FIG. 13.

That is, on receipt of the notification of starting forwarding the latest advertisement information from the client 100 in a step S41, the CPU 408 advances to a step S43 so as to receive in order the latest advertisement information forwarded from the client 100. Then, after confirming that it is completed to receive the advertisement information in a step S45, the CPU 408 advances to a step S47 so as to update the advertisement information within the memory 426 by the received latest advertisement information. Then, after updating this advertisement information, the CPU 408 returns to its own main routine.

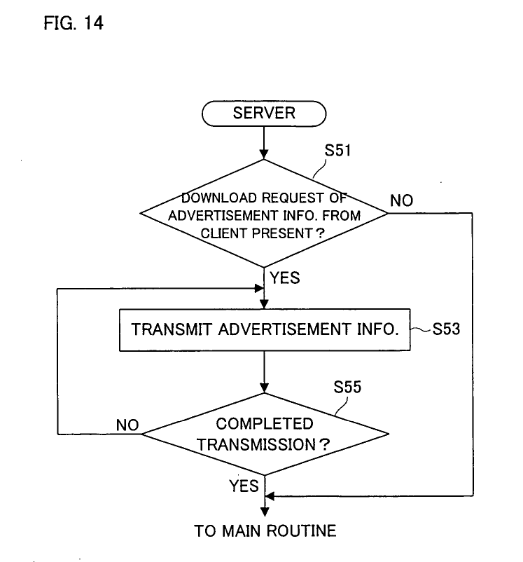

On the other hand, on receipt of the download request of the advertisement information from the client 100, the CPU 304 of each server 300, 300, . . . , processes a flowchart shown in FIG. 14.

That is, on receipt of the download request of the advertisement information from the client 100 in a step S51, the CPU 304 of the server 300 that received this download request advances to a step S53 so as to transmit to the client 100 the latest advertisement information held in the database 306. Then, after confirming that it is completed to transmit its own advertisement information in a step S55, the CPU 304 returns to its own main routine (not shown).

Thus, according to this embodiment, when the music reproducing apparatus 400 is connected to the client 100, the client 100 reads out the advertisement information stored in the memory 426 of the music reproducing apparatus 400. Therefore, this eliminates a need to take the trouble to access each server 300, 300, . . . , so as to browse each homepage, and enables to easily know what kind of services each offers. Therefore, this makes it possible to drastically reduce trouble and costs incurred when the operator operating the client 100 and the music reproducing apparatus 400, that is, a user on a receiving side of delivered services, downloads a desired music content.

Furthermore, if the above-described “latest information obtaining” button 120a is clicked, it is possible to obtain the latest advertisement information that each server 300, 300, . . . , has. In addition, this latest advertisement information updates the advertisement information within the memory 426 of the music reproducing apparatus 400.

Furthermore, the client 100 and the music reproducing apparatus 400 that the user has function as a kind of an advertising medium. Therefore, for an administrative side of each server 300, 300, . . . , that is, a side that offers the delivery service (delivery agent), it has the advantage of directly advertising and promoting itself toward the user.

Then, for a manufacturing side of the music reproducing apparatus 400, that is, a maker or manufacturer, when assigning storing areas 426a, 426a, , of the memory 426 to an administrator of each server 300, 300, . . . , for example, it is also possible to collect charges such as a registration fee in advance or regularly from each administrator. In addition, as a result of the collected fees being reinvested into a product, the user can enjoy such a merit as to purchase the music reproducing apparatus 400 at a low price.

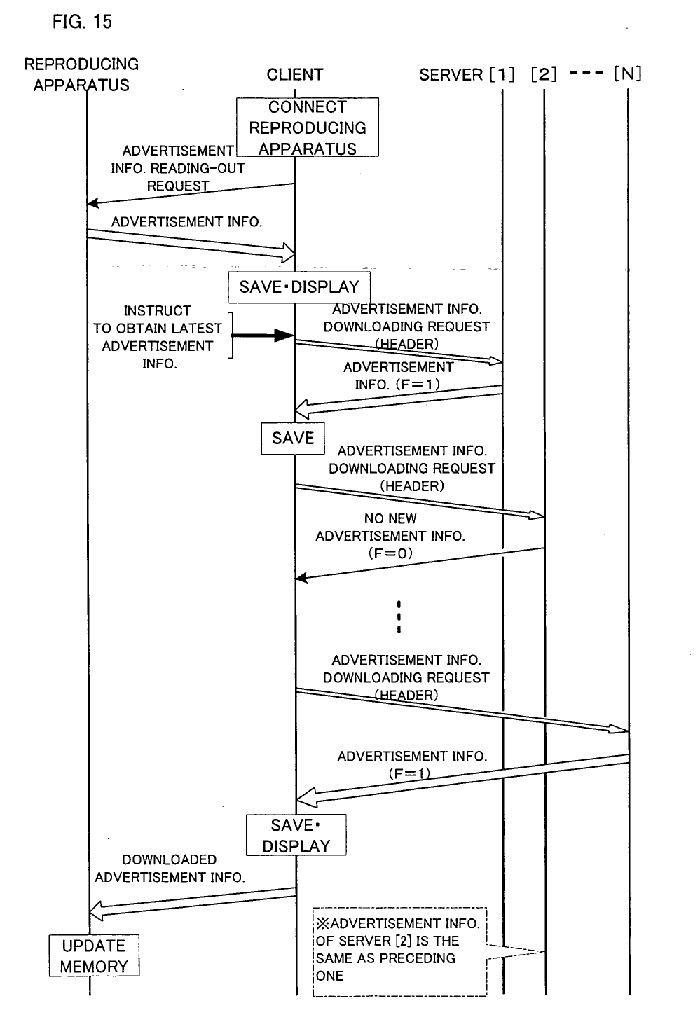

In another embodiment, when the “latest information obtaining” button 120 is clicked, the client 100 downloads the advertisement information from each server 300, 300, . . . , according to a flow shown in FIG. 15, instead of FIG. 6. It is noted that in this FIG. 15, a portion in which the client 100 accesses each server 300, 300, . . . , so as to download the latest advertisement information is different from that of FIG. 6. Therefore, a portion different from FIG. 6 will be herein primarily described, and descriptions in other portions will be omitted.

That is, according to a flow in FIG. 15, when requesting downloading the advertisement information to each server 300, 300, . . . , from the client 100, the above-described header shown in FIG. 4 is to be transmitted together with this. In this header, various kinds of information such as date on which the advertisement information is updated in each server 300, 300, . . . , and etc. are included. Then, in each server 300, 300, . . . , on receipt of the download request of the advertisement information from the client 100, an updating date included in the header and the updating data of the advertisement information presently held by its own are compared. Herein, if the updating date of the advertisement information held by its own is newer than the updating date included in the received header, this situation is expressed by rendering a flag F set in advance F=1. Then, together with this flag F, the advertisement information held by its own is transmitted to the client 100. On the other hand, if the updating date of the advertisement information held by its own is the same as the updating date included in the header, the flag F is rendered F=0, and only the flag F is transmitted to the client 100.

On the client 100 side, it is recognized whether or not the advertisement information of each server 300,300, . . . , is updated depending on a numeral, that is, “1” or “2”, of the flag F transmitted from each server 300, 300, . . . ,. Then, only when the flag F is equal to 1 (F=1), the advertisement information is downloaded.

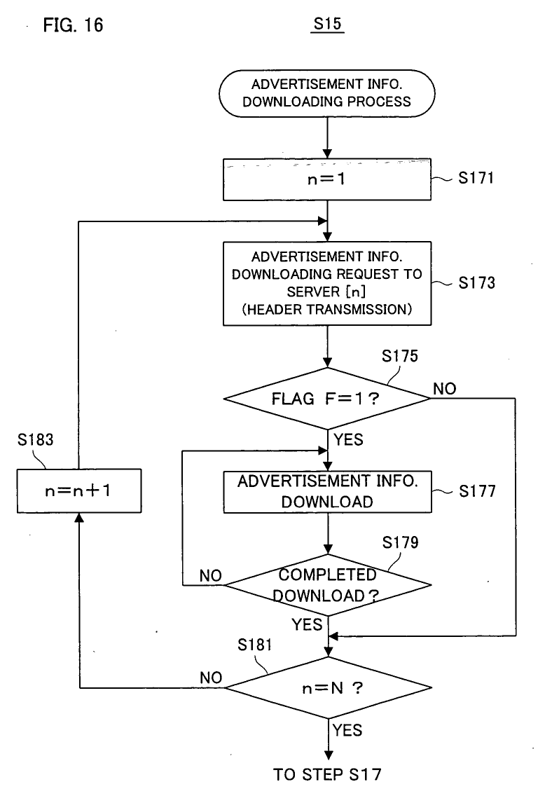

When the advertisement information is downloaded from each server 300, 300, . . . , according to the flow shown in this FIG. 15, the CPU 106 of the client 100 processes a flowchart shown in FIG. 16, instead of a flowchart shown in FIG. 11, as the above-described advertisement information downloading process.

That is, firstly, the CPU 106 sets the server index n to the initial value (n=1) in a step S171. Then, the CPU 106 issues to the [n th] server 300 the download request of the advertisement information in a step S173. At the same time, the CPU 106 transmits a header portion of the advertisement information corresponding to the [n th] server 300. Then, in a step S175, a content of the flag F transmitted from the [n th] server 300 is confirmed, and when the flag F is equal to 1 (F=1), the CPU 106 advances to a step S177 so as to execute downloading the advertisement information. Then, in a step S179, after confirming that it is completed to download, the CPU 106 advances to a step S181 so as to confirm whether or not the download request of the advertisement information is issued to all servers 300, 300, . . . ,. On the other hand, if the flag F is equal to 0 (F=0) in the step S175, the CPU 106 skips the steps S177 and S179, and then, advances to the step S181. In the step S181, if it is determined that the download request of the advertisement information is not yet issued to all the servers 300, 300, . . . , the CPU 106 advances to a step S183 for issuing the download request of the advertisement information to a subsequent server 300, and then, returns to the step S173. In contrary, if it is determined that the download request of the advertisement information is issued to all the servers 300, 300, . . . , in the step S181, the CPU 106 ends this advertisement information download process, and advances to the step S17 shown in FIG. 10.

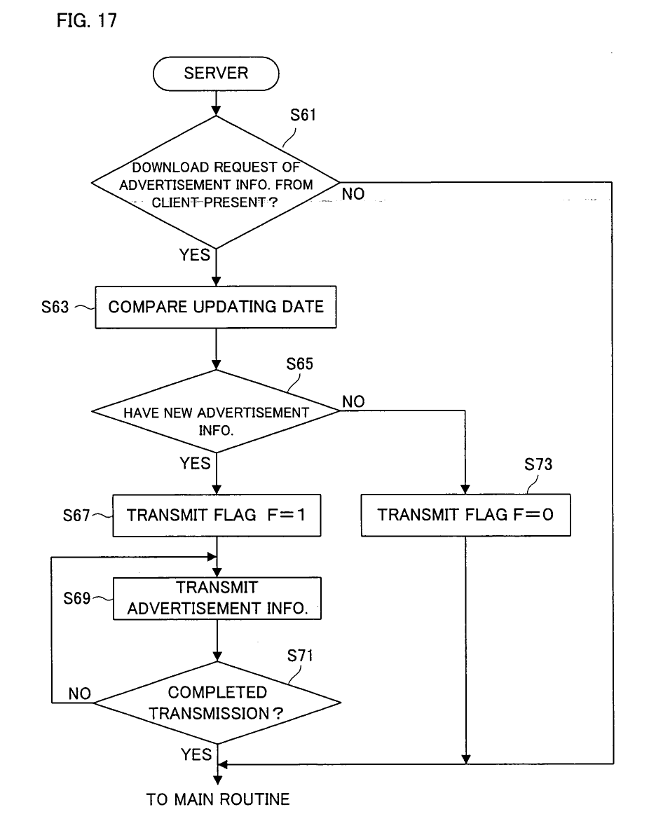

In correspondence with such the process of the CPU 106 on the client side, the CPU 304 of each server 300, 300, . . . , processes a flowchart shown in FIG. 17.

That is, on receipt of the download request of the advertisement information from the client 100 in a step S61, the CPU 304 of the server 300 that received this download request advances to a step S63 so as to compare the updating date included in the header received along with this download request and the updating date of the advertisement information presently held in the database 306. Then, when it is determined that the updating date of the advertisement information held in the database 306 is newer than the updating date included in the received header in a step S65, the CPU 304 advances to a step S67 so as to render the flag F F=1, and transmits the flag F to the client 100. Then, after transmitting this flag F, the CPU 304 advances to a step S69 so as to transmit the advertisement information held in the database 306 to the client 100. After confirming that it is completed to transmit the advertisement information in a step S71, the CPU 304 returns to its own main routine. On the other hand, when it is determined that the updating date of the advertisement information held in the database 306 is the same as the updating date included in the received header in the step S65, the CPU 304 advances to a step S73 so as to render the flag F F=0, and transmits this flag F to the client 100. Then, after transmitting this flag F, the CPU 304 returns to the main routine.

If the process follows a flow thus shown in FIG. 15, it becomes possible to download only the advertisement information newer than the advertisement information stored within the memory 426 of the music reproducing apparatus 400. Therefore, compared to the flow in FIG. 6 in which the advertisement information is without exception downloaded from all servers 300, 300, . . . , it is possible to effectively download the advertisement information.

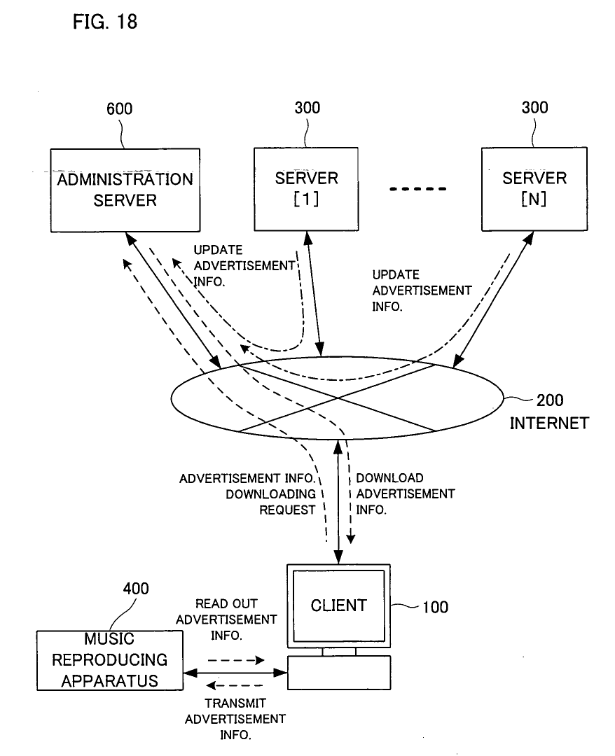

Furthermore, in another embodiment, an administration-use server 600 is laid in addition to each server 300, 300, . . . , as shown in FIG. 18. Then, all the advertisement information of each server 300, 300, . . . , are to be held in this administration server 600, and the advertisement information of each server 300, 300, . . . , is to be downloaded from this administration server 600. It is noted that when the advertisement information is updated in each server 300, 300, . . . , the advertisement information held in the administration server 600 is to be updated at the same time.

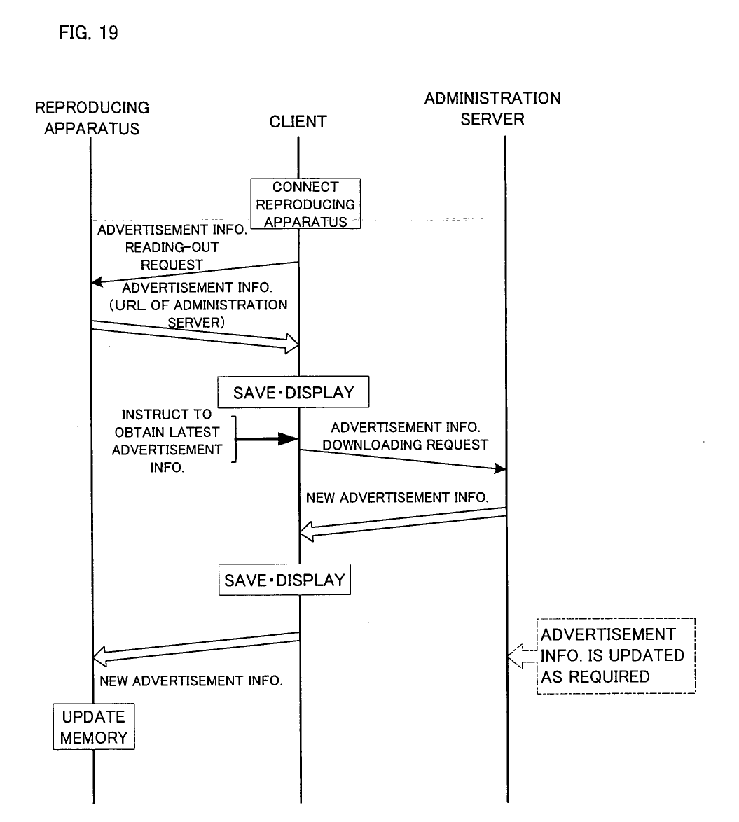

As a result of the advertisement information of each server 300, 300, . . . , being administered in a unitary manner by the single administration server 600, it is possible to concentrate an access destination of the client 100 at a time of downloading the advertisement information of each server 300, 300, . . . , in a single center, i.e. the administration server 600 as shown in FIG. 19. Therefore, it is possible to further enhance effectiveness than at a time of downloading the advertisement information of each server 300, 300, . . . ,. It is noted that URL information for accessing the administration server 600 is recorded in the memory 426 of the music reproducing apparatus 400 in advance. Furthermore, when the advertisement information is read out from the memory 426 of the music reproducing apparatus 400, the client 100 reads out the URL information of the administration server 600.

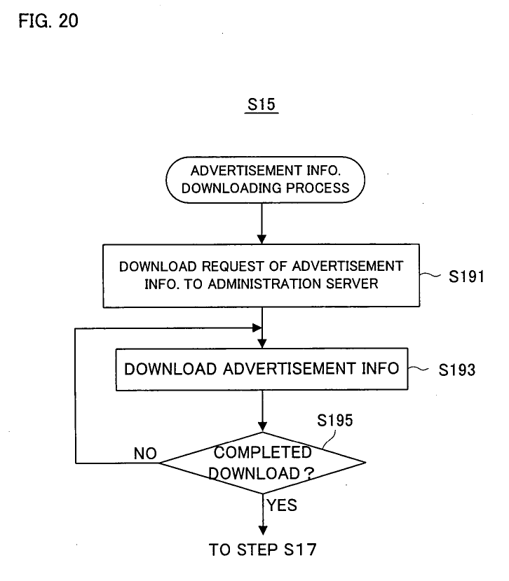

When thus downloading the advertisement information of each server 300, 300, . . . , from the administration server 600, the CPU 106 of the client 100 processes a flowchart shown in FIG. 20, instead of the flowchart shown in FIG. 11 or FIG. 16, as the above-described advertisement information downloading process.

That is, firstly, the CPU 106 accesses the administration server 600 so as to request downloading the advertisement information in a step S191. Then, the downloading of the advertisement information is executed in a step S193, and after confirming that it is completed to download in a step S195, the CPU 106 ends this advertisement information downloading process, and then, advances to the step S17 shown in FIG. 10.

It is noted that in correspondence with the process of the CPU 106 on the side of the client 100, the administration server 600 carries out the same process as described above in FIG. 14. Therefore, descriptions regarding the process of the administration server 600 will be herein omitted.

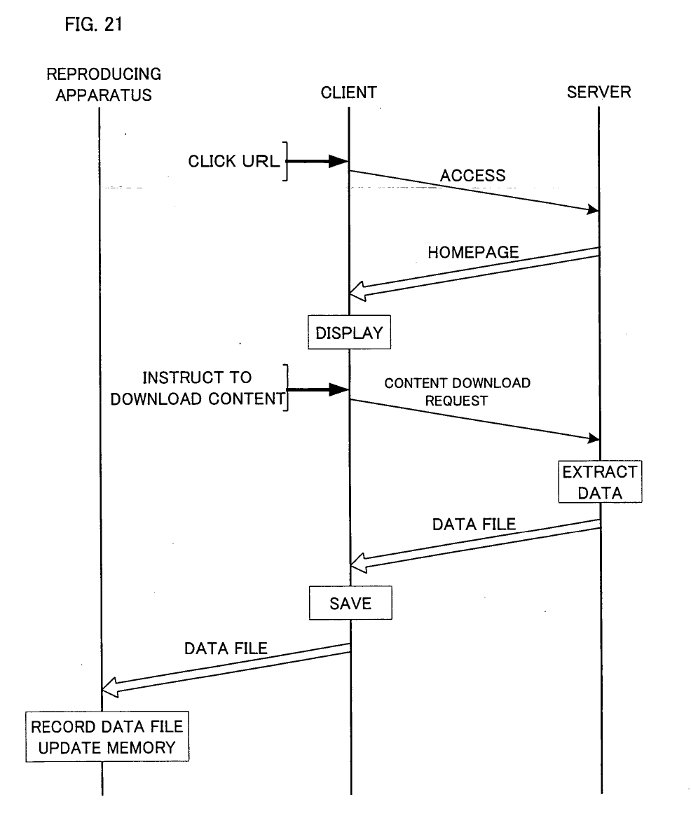

In a certain embodiment, when downloading a music content from an arbitrary server 300, it is possible to download the advertisement information held in the server 300 in addition to this music content. This will be described in detail by referring to FIG. 21.

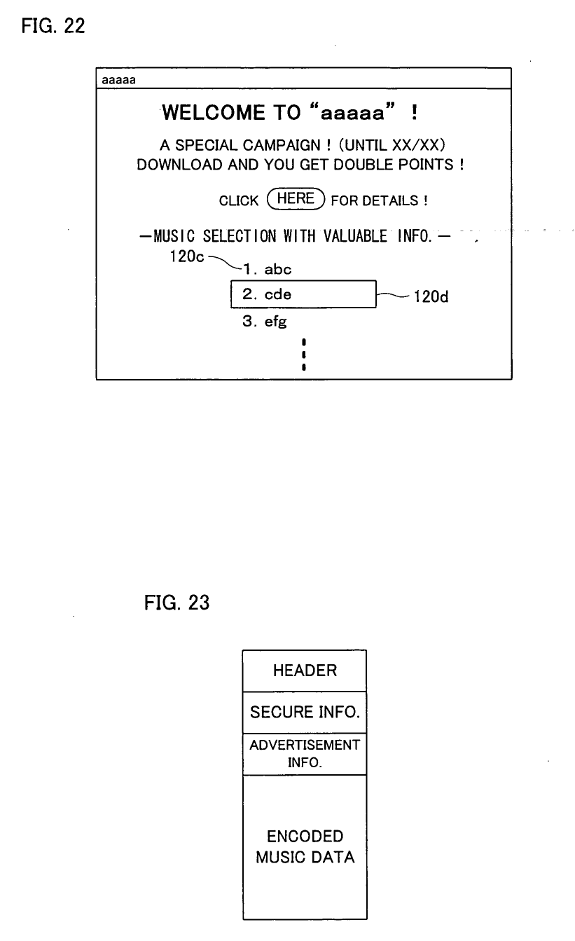

That is, provided that now the client 100 receives from the operator an instruction of accessing the arbitrary server 300. This instruction is applied by clicking a URL 120b of the arbitrary server 300 by the mouse 118 on the screen shown in the above-described FIG. 7. The client 100 accesses the arbitrary server 300 according to the applied instruction. In response thereto, data of a homepage is transmitted to the client 100 from the server 300 of the access destination. Thereby, a homepage screen as shown in FIG. 22 is displayed on the display 120 of the client 100. It is noted that the same FIG. 22 indicates a screen when accessed to the [1st] server 300.

Then, if the operator applies an instruction of downloading the desired music content on the homepage shown in FIG. 22, more specifically, if a cursor 120d is placed on the desired content out of a table of music contents 120c downloadable from this homepage, and the mouse 118 is clicked, the client 100 issues to the server 300 of the access destination the download request of the music content. The server 300 of the access destination extracts a data file corresponding to the music content designated from its own database 306 on receipt of this download request. Structure of this data file is shown in FIG. 23.

As shown in this FIG. 23, subsequent to the header of the data file, secure information, advertisement information, and encoded music data are stored in this order. Herein, the secure information is encoding key information in order that the music data is not illegally copied, and it is possible to decipher a code written on the music data and decode the music data by using this encoding key.

Then, the server 300 transmits to the client 100 the data file extracted from the database 306. The transmitted data file is downloaded into the hard disk 108 within the client 100, and this downloaded data file is forwarded to the music reproducing apparatus 400.

The music reproducing apparatus 400 stores the data file to be forwarded into the memory card 402 as in the above-described procedure. At the same time, the music reproducing apparatus 400 updates the corresponding advertisement information out of the advertisement information within the memory 426 (advertisement information corresponding to the server 300 of the access destination) by the advertisement information included in the data file.

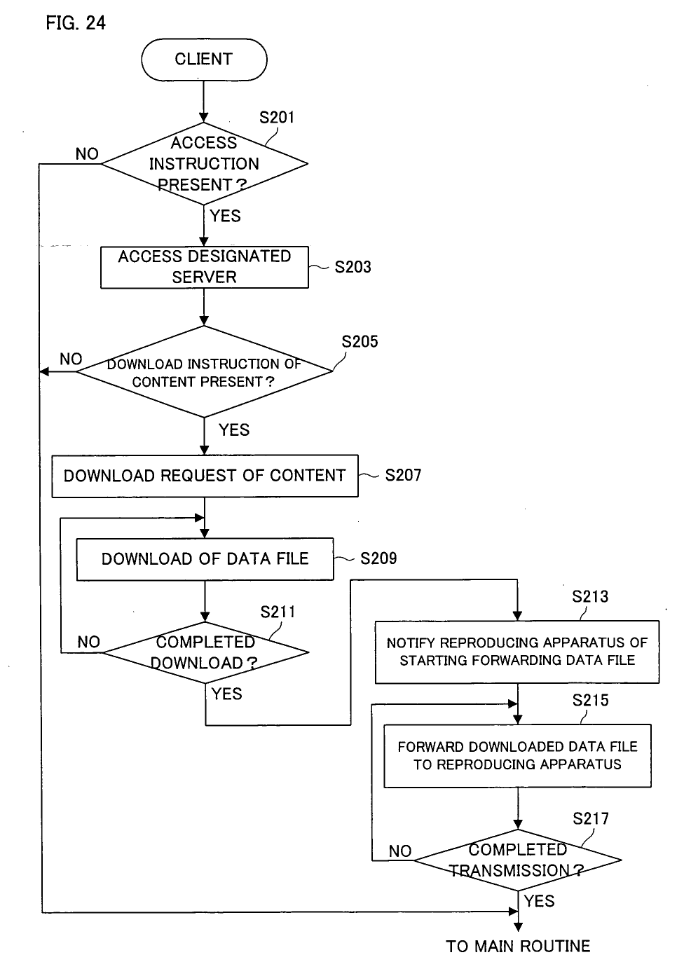

When thus accessing the arbitrary server 300 so as to download from the server 300 the data file including the advertisement information, the CPU 106 of the client 100 processes a flowchart shown in FIG. 24.

As shown in this FIG. 24, when the CPU 106 recognizes that the CPU 106 is instructed by the operator to access the arbitrary server 300 in a step S201, that is, that the arbitrary URL 120a is clicked on the screen in FIG. 7, the CPU 106 advances to a step S203 so as to access the designated server 300. Then, in a step S205, when the CPU 106 recognizes that the CPU 106 is instructed by the operator to download the arbitrary music content, that is, that with the cursor 120d placing on the arbitrary music content on the screen in FIG. 22, the mouse 118 is clicked, the CPU 106 advances to a step S207 so as to request downloading the music content to the access destination server 300. Then, after this request, the CPU 106 advances to a step S209 so as to execute downloading the data file corresponding to the request music content. After confirming that it is completed to download the data file in a step S211, the CPU 106 advances to a step S213 for forwarding the downloaded data file to the music reproducing apparatus 400, and informs the music reproducing apparatus 400 of starting forwarding the data file. After this notification, the CPU 106 advances to a step S215 so as to forward the downloaded data file to the music reproducing apparatus 400. Then, after confirming that it is completed to forward the data file in a step S217, the CPU 106 returns to the main routine.

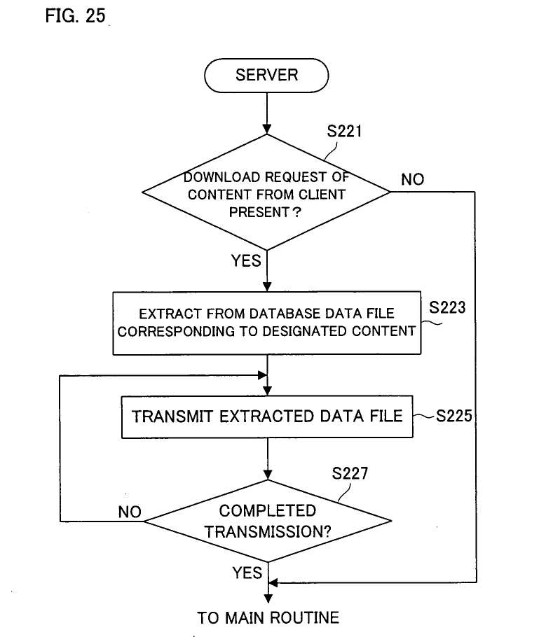

In correspondence with such the process of the CPU 106 on the side of the client 100, the CPU 304 of the server 300 of the access destination processes a flowchart shown in FIG. 25.

That is, on receipt of the download request of the music content from the client 100 in a step S221, the CPU 304 advances to a step S223 so as to extract from the database 306 the data file corresponding to the requested music content. Then, the CPU 304 transmits to the client 100 the extracted data file in a step S225. After confirming that it is completed to transmit the data file in a step S227, the CPU 304 returns to its own main routine.

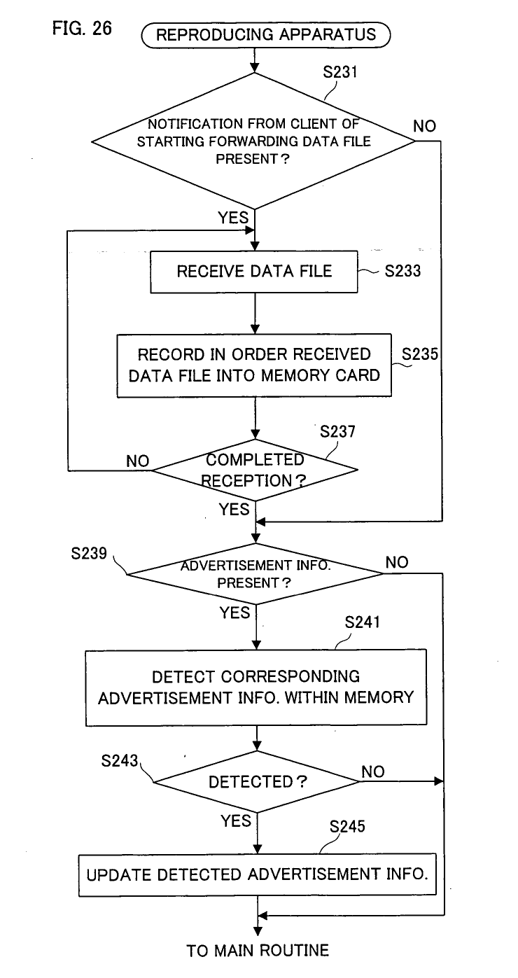

Furthermore, on receipt of a notification of starting forwarding the data file from the client 100, the CPU 408 of the music reproducing apparatus 400 processes a flowchart shown in FIG. 26.

As shown in this FIG. 26, on receipt of the notification of starting forwarding the data file from the client 100 in a step S231, the CPU 408 advances to a step S233 so as to receive in order the data file forwarded from the client 100. Then, the CPU 408 records in order the received data file into the memory card 402 in a step S235. After confirming that it is completed to receive the data file in a step S237, the CPU 408 advances to a step S239 in order to investigate whether or not the advertisement information is included in the received data file. Herein, in a case that the advertisement information is included in the received data file, the CPU 408 advances to a step S241 so as to detect whether or not the advertisement information corresponding to the advertisement information included in the received data file is stored in the memory 426. Then, if it is confirmed that the corresponding advertisement information is detected in a step S243, the CPU 408 advances to a step S245 so as to update the detected advertisement information by the advertisement information included in the data file. Then, after updating this advertisement information, the CPU 408 returns to its own main routine.

On the other hand, in a case of confirming that the advertisement information is not included in the data file in the step S239, the CPU 408 skips the steps from S241 to S245, and directly returns to the main routine. In addition, in a case of not being capable of detecting from the memory 426 the advertisement information corresponding to the advertisement information included in the data file in the step S243, the CPU 408 also skips the step S245, and directly returns to the main routine.

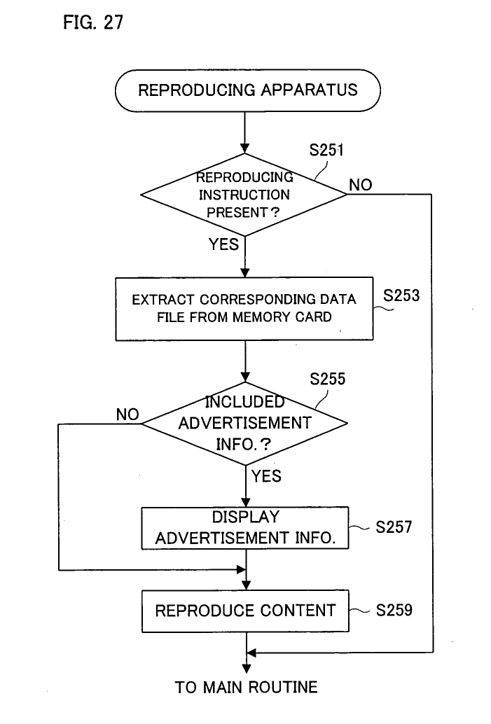

In still another embodiment, in a case that the advertisement information is included in the data file when the music reproducing apparatus 400 reproduces the music based on the data file recorded in the memory card 402, its advertisement information is displayed on the display 428 of the music reproducing apparatus 400. In reproducing the music in this manner, the CPU 408 of the music reproducing apparatus 400 processes a flowchart shown in FIG. 27.

That is, when it is confirmed that an instruction of reproducing the arbitrary music is applied from the operator (that the above-described reproduction key is depressed) in the step S251, the CPU 408 advances to a step S253 so as to extract the data file corresponding to the music from the memory card 402. Then, the CPU 408 investigates whether or not the advertisement information is included in the extracted data file in a step S255. Herein, in a case of determining that the advertisement information is included in the extracted data file, the CPU 408 advances to a step S257 so as to display the advertisement information on the display 428, and reproduce the music in a step S259. On the other hand, in a case of determining that the advertisement information is not included in the data file in the step S255, the CPU 408 skips the step S257, and advances to the step S259 so as to reproduce the music.

In the preceding embodiments, although a case of handling the music as the content is described, it is needless to say that the present invention is applicable to a case of handling another content such as an image, text information, and etc., for example. Furthermore, the client 100 may be formed of not only a personal computer, but also another communication terminal such as a PDA (Personal Digital Assistant), for example.

In addition, although the advertisement information is described by a text as shown in FIG. 7 or FIG. 8, this is not always the case. This may be described by using an image, a drawing, and etc., for example. Furthermore, in a case that the client 100 has an internal calendar function, a background, a color, and etc. of the advertisement information are modified (that is, programmed) in correspondence to the date of the calendar, as a result, various kinds and manners of advertisements will be possible. In addition, instead of limiting to a visual manner such as the text, the image, and etc., the advertisement information may be expressed by an audible manner such as voices, a music, and etc.

Furthermore, when the above-described “latest information obtaining” button 120a is clicked, the client 100 downloads from each server 300, 300, . . . , or the administration server 600 the advertisement information. However, this is not always the case. It may be structured that after the client 100 reads out the advertisement information from the memory 426 of the music reproducing apparatus 400, the advertisement information is automatically downloaded from each server 300, 300, . . . , or the administration server 600, for example.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content receiving program executed by a client computer to which a server computer system that delivers a content and a content reproducing apparatus that reproduces said delivered content are connected as required, comprising following:
(a) a reading-out step for reading out advertisement information from a memory of said content reproducing apparatus when said content reproducing apparatus is connected to said client computer;
(b) a connecting step for connecting the client computer to the server computer system based on said advertisement information; and
(c) an updating step for updating said advertisement information of said memory by said new advertisement information transmitted from said server computer system.

2. A content receiving program according to claim 1, wherein
said server computer system includes a plurality of server computers that hold said content and said advertisement information,
said advertisement information includes address information of said server computer of an advertisement transmitting source, and
in said connecting step (b), a connection is made to each of said server computers according to said address information.

3. A content receiving program according to claim 2, wherein
said memory stores said advertisement information for each of said server computers, and
said updating step (c) includes a detecting step (c1) for detecting from said memory said advertisement information corresponding to said connecting server computer, and an advertisement information updating step (c2) for updating said advertisement information detected in said detecting step by said new advertisement information transmitted from said connecting server computer.

4. A content receiving program according to claim 3, wherein
said advertisement information stored in said memory includes timing information,
said updating step (c) further includes a transmitting step (c3) for transmitting to said connecting server computer said timing information included in said advertisement information detected in said detecting step, and
in said advertisement information updating step (c2), an updating is carried out when said new advertisement information is transmitted toward said timing information.

5. A content receiving program according to claim 1, wherein
said server computer system includes a plurality of first servers that hold the content, and a second server that holds said advertisement information, and
in said connecting step (b), a connection is made to the second server computer.

6. A content receiving program according to claim 5, wherein
said advertisement information includes address information of said second computer server, and
in said connecting step (b), a connection is made to the second server computer according to said address information.

7. A content receiving method executed by a client computer to which a server computer system that delivers a content and a content reproducing apparatus that reproduces said content to be delivered are connected as required, comprising following steps:
(a) a step for reading out advertisement information from a memory of said content reproducing apparatus when said content reproducing apparatus is connected to said client computer;
(b) a step for connecting the client computer to said server computer system based on said advertisement information; and
(c) a step for updating said advertisement information of said memory by said new advertisement information transmitted from said server computer system.

8. A client computer to which a server computer system that delivers a content and a content reproducing apparatus that reproduces said content to be delivered are connected as required, comprising:
a reading-out means for reading out advertisement information from a memory of said content reproducing apparatus when said content reproducing apparatus is connected to the client computer;
a connection means for connecting the client computer to said server computer system based on said advertisement information; and
an updating means for updating said advertisement information of said memory by said new advertisement information transmitted from said server computer system.

9. A content receiving system, comprising:
a server computer system that delivers a content;
a content reproducing apparatus that reproduces said content to be delivered; and
a client computer that reads out advertisement information from a memory of said content reproducing apparatus, connects the client computer to said server system based on said advertisement information, and updates said advertisement information of said memory by said new advertisement information transmitted from said server system computer.

10. A client computer to which a server computer system that delivers a content and a content reproducing apparatus that reproduces said content to be delivered are connected as required, comprising following programs:
a reading-out program for reading out advertisement information from a memory of said content reproducing apparatus when said content reproducing apparatus is connected to said the client computer;
a connecting program for connecting to said server computer system based on said advertisement information; and
an updating program for updating said advertisement information of said memory by said new advertisement information transmitted from said server computer system.

11. A client computer according to claim 10, wherein
said server computer system includes a plurality of server computers that hold said content and said advertisement information,
said advertisement information includes address information of said server computer of an advertisement transmitting source, and
in said connecting program, a connection is made to each of said server computers according to said address information.

12. A client computer according to claim 11, wherein
said memory stores said advertisement information for each of said server computers,
said updating program includes a detection program for detecting from said memory said advertisement information corresponding to said connecting server computer, and an advertisement information updating program for updating said advertisement information detected by said detection program by said new advertisement information transmitted from said connecting server computer.

13. A client computer according to claim 12, wherein
said advertisement information stored in said memory includes timing information showing a timing of creating the advertisement,
said updating program further includes a transmitting program for transmitting to said connecting server computer said timing information included in said advertisement information detected by said detection program,
in said advertisement information updating program, an updating is carried out when said new advertisement information is transmitted toward said season information.

14. A client computer according to claim 10, wherein
said server computer system includes a plurality of first server computers that hold the content, and a second server computer that holds said advertisement information,
in said connecting program, a connection is made to said second server computer.

15. A client server computer according to claim 14, wherein
said advertisement information includes address information of said second server computer,
in said connecting program, a connection is made to said second server computer according to said address information.
